(19) United States
(12) Patent Application Publication
(10) Pub. No.: US 2021/0043188 A1
(43) Pub. Date: Feb. 11, 2021

(54) PERSONAL AVATAR MEMORIAL

(71) Applicant: Sony Corporation, Tokyo (JP)

(72) Inventors: Brant Candelore, Poway, CA (US); Mahyar Nejat, La Jolla, CA (US)

(73) Assignee: Sony Corporation, Tokyo (JP)

(21) Appl. No.: 16/531,727

(22) Filed: Aug. 5, 2019

(51) Int. Cl. G10L 13/04; G10L 13/08

(52) U.S. Cl. CPC G10L 13/043; G10L 13/08

(57) ABSTRACT

Implementations generally relate to a memorial avatar. In some implementations, a method includes obtaining a plurality of characteristics for a voice of a first user. The method further includes generating a digital voice based on the plurality of characteristics. The method further includes receiving input from a second user. The method further includes communicating with the second user using the digital voice.

### BACKGROUND

An avatar is an icon or image representing a particular person. For example, an avatar may be a character that represents an online user in an online community. An avatar may look like a particular person or user in a virtual environment.

### SUMMARY

Implementations generally relate to a memorial avatar. In some implementations, a system includes one or more processors, and includes logic encoded in one or more non-transitory computer-readable storage media for execution by the one or more processors. When executed, the logic is operable to cause the one or more processors to perform operations including: obtaining a plurality of characteristics for a voice of a first user; generating a digital voice based on the plurality of characteristics; receiving input from a second user; and communicating with the second user using the digital voice.

With further regard to the system, in some implementations, the logic when executed is further operable to cause the one or more processors to perform operations including associating the digital voice with an avatar, and where the avatar communicates with the second user using the digital voice. In some implementations, the communicating is performed in a predetermined natural language. In some implementations, the input is text. In some implementations, the logic when executed is further operable to cause the one or more processors to perform operations including: receiving text, where the input is the text; converting the text to audio; and outputting the audio in the digital voice. In some implementations, the input is audio. In some implementations, the logic when executed is further operable to cause the one or more processors to perform operations including: obtaining a second plurality of characteristics for a second voice of the first user; generating a second digital voice based on the second plurality of characteristics; enabling the second user to select the second digital voice; and communicating with the second user using the second digital voice.

In some embodiments, a non-transitory computer-readable storage medium with program instructions thereon is provided. When executed by one or more processors, the instructions are operable to cause the one or more processors to perform operations including: obtaining a plurality of characteristics for a voice of a first user; generating a digital voice based on the plurality of characteristics; receiving input from a second user; and communicating with the second user using the digital voice.

With further regard to the computer-readable storage medium, in some implementations, the instructions when executed are further operable to cause the one or more processors to perform operations including associating the digital voice with an avatar, and where the avatar communicates with the second user using the digital voice. In some implementations, the communicating is performed in a predetermined natural language. In some implementations, the input is text. In some implementations, the instructions when executed are further operable to cause the one or more processors to perform operations including: receiving text, where the input is the text; converting the text to audio; and outputting the audio in the digital voice. In some implementations, the input is audio. In some implementations, the instructions when executed are further operable to cause the one or more processors to perform operations including: obtaining a second plurality of characteristics for a second voice of the first user; generating a second digital voice based on the second plurality of characteristics; enabling the second user to select the second digital voice; and communicating with the second user using the second digital voice.

In some implementations, a method includes: obtaining a plurality of characteristics for a voice of a first user; generating a digital voice based on the plurality of characteristics; receiving input from a second user; and communicating with the second user using the digital voice.

With further regard to the method, in some implementations, the method further includes associating the digital voice with an avatar, and where the avatar communicates with the second user using the digital voice. In some implementations, the communicating is performed in a predetermined natural language. In some implementations, the input is text. In some implementations, the method further includes: receiving text, where the input is the text; converting the text to audio; and outputting the audio in the digital voice. In some implementations, the input is audio.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example memorial environment, which may be used for some implementations described herein.

FIG. 2 is an example flow diagram for communicating with a user using a generated digital voice, according to some implementations.

FIG. 3 is an example flow diagram for outputting a digital voice of a person based on text from that person, according to some implementations.

FIG. 4 is an example flow diagram for communicating with a user using an alternative digital voice, according to some implementations.

FIG. 5 is a block diagram of an example network environment, which may be used for some implementations described herein.

FIG. 6 is a block diagram of an example computer system, which may be used for some implementations described herein.

### DETAILED DESCRIPTION

Implementations described herein provide a memorial avatar. As described in more detail herein, in various implementations, a system provides an avatar representing a person who interacts with a user or users using verbal communication (e.g., natural language) based on the voice of the person, where the system causes the avatar to talk with the speech traits of the person. In various implementations, the system customizes the avatar specifically for the person.

When a person passes away, the person can often be forgotten in a relatively short amount of time. It may be a part of the natural grief and emotional healing process. In various implementations, the system provides an avatar with a voice that resembles the actual voice of a deceased person as a way to keep his or her memory alive.

In various implementations, the system obtains characteristics for the voice of a person, referred to as a first user. The system then determines characteristics of the voice. The system then generates a digital voice based on the plurality of characteristics. The system then receives input from a second user. The system then communicates with the second user using the digital voice.

Although implementations disclosed herein are described in the context of a memorial avatar, the implementations may also apply to avatars in different contexts. For example, the person whose voice is used to generate a digital voice may still be alive, and yet not in the presence of others. Those other people may communicate with the avatar as if interacting with the person represented by the avatar.

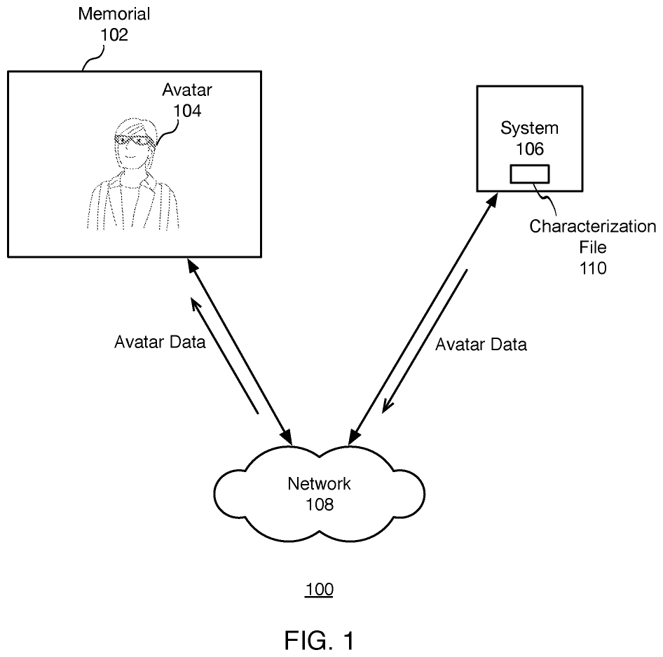

FIG. 1 illustrates a block diagram of an example memorial environment 100, which may be used for some implementations described herein. In some implementations, memorial environment 100 includes a memorial 102, an avatar 104, a system 106, and a network 108. In some implementations, the network may be the Internet. In some implementations, the network may include a combination of networks such as the Internet, a wide area network (WAN), a local area network (LAN), a Wi-Fi network, a Bluetooth network, near-field communication (NFC) network, cable network, etc.

In some implementations, avatar 104 is associated with a characterization file 110 that is accessible by system 106. The system may store avatar data in characterization file 110. In this particular example implementation, the avatar data is stored in characterization file 110, which is stored at system 106. In some implementations, characterization file 110 may be stored remotely from system 106 and accessible by system 106.

In various implementations, the avatar 104 visually resembles a person associated with avatar 104. As described in more detail herein, avatar 104 also interacts with users using the voice of the person associated with avatar 104. As a result, avatar 104 has the image of and speech traits of that person. This is beneficial in scenarios, for example, where the person represented by avatar 104 is deceased and avatar 104 helps to keep his or her memory alive.

Implementations may apply to any network system and/or may apply locally for an individual user. For example, system 106 may perform the implementations described herein on a stand-alone computer, tablet computer, smartphone, etc. System 106 may perform implementations described herein alone or in combination with other devices.

In the various implementations described herein, a processor of system 106 causes the elements described herein (e.g., avatar, etc.) to be displayed in a user interface on one or more display screens, and causes the avatar's voice to be outputted via one or more speakers.

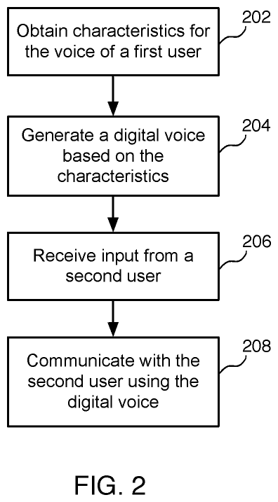

FIG. 2 is an example flow diagram for communicating with a user using a generated digital voice, according to some implementations. Referring to both FIGS. 1 and 2, a method is initiated at block 202, where a system such as system 106 obtains characteristics for the voice of a first user. The terms target person, target user, and first user may be used interchangeably. The first user may also be referred to as the target user, where the avatar described in FIG. 1 represents the first/target user.

In various implementations, the target/first user may but need not access the system himself or herself. For example, in some implementations, the first user may provide or send or input the characteristics for his or her voice to the system. In various implementations, the characteristics may be stored and transferred to the system in a file (e.g., characterization file, configuration file, etc.). This may occur in scenarios where the first user is remote from a second user, and where the system enables a second user and other users to interact with a avatar having the voice of the first user. The term second user represents a different user who may want to listen to the voice of the first user in connection with particular media (e.g., text that the first user authored, etc.). In some implementations, the second user may provide or send or input the characteristics of the first user's voice to the system. This may occur in scenarios, where the first user is deceased, and where the system enables the second user and other users to interact with an avatar having the voice of the first user.

In some implementations, the system may obtain the characteristics for the first user's voice from any suitable local and/or remote storage location. In some implementations, the system may determine the characteristics of the first user's voice based on a recorded voice. In various implementations, the system may utilize deep neural network technology to learn the person's voice by characterizing aspects of the person's voice. For example, the system may determine the pitch range of the recorded voice, including the rise and fall and/or inflections of the recorded voice. The system may determine the volume or loudness of the recorded voice. The system may determine the pace of the recorded voice. The system may determine pauses or silence of the recorded voice. The system may determine the resonance or timbre of the recorded voice. The system may determine the intonation of the recorded voice. In various implementations, the system utilizes deep neural network technology to analyze the recorded voice for patterns and statistics of the characteristics, including averages, frequency, etc. In some implementations, the system may detect dialects, accents and/or other characterizing aspects of the recorded voice.

At block 204, the system generates a digital voice based on the characteristics of the user's voice. In various implementations, the system associates the digital voice with the avatar, and where the avatar communicates with the second user using the digital voice. The system utilizes the characterization information in generating the digital voice. As such, the system generates a digital voice that closely resembles the actual or true voice of the first user.

At block 206, the system receives input from a second user. The wording “second user” is used to distinguish the second user from the first user. As indicated above, the avatar described in FIG. 1 represents the first/target user. The second user represents a different user who may want to listen to the voice of the first user in connection with particular media (e.g., text that the first user authored, etc.).

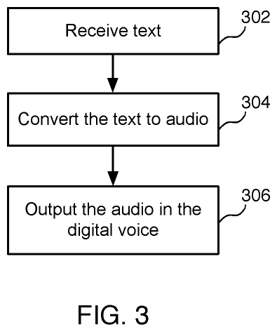

In some implementations, the input is text. For example, the second user may scan and/or send the text to the system. The system then reads and stores the text. Example implementations are described in more detail below in connection with FIG. 3.

At block 208, the system communicates with the second user using the digital voice. For example, the system may generate an avatar and cause the avatar to be displayed to the second user. In various implementations, the system provides an avatar with a voice that resembles the actual voice of a person (e.g., the first user). If the person is deceased, the voice of the person is a way to keep his or her memory alive for others.

In various implementations, the communication is performed in a predetermined natural language. For example, the predetermined natural language may be English, or any other natural language. As such, if the second user provides text to the system, the system may read back the text to the second user in the first person's voice.

When people pass, they often can be forgotten in a relatively short amount of time, which may be a part of the natural grief and emotional healing process. The system customizes the avatar the deceased (e.g., relative, friend, etc.).

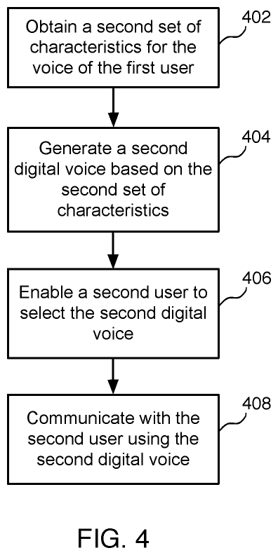

FIG. 3 is an example flow diagram for outputting a digital voice of a person based on text from that person, according to some implementations. Referring to both FIGS. 1 and 4, a method is initiated at block 302, where a system such as system 106 receives text, where the input is the text.

At block 304, the system converts the text to audio. In various implementations, the system may utilize a text-to-speech engine to covert the text to audio, where the audio is the digital voice that has been personalized with the talking traits of the first person.

At block 306, the system outputs the audio in the digital voice for communication with another user (e.g., the second user).

While various implementations are described in the context of text-to-speech, implementations may be applied to other applications. For example, in some implementations, the input is audio. In an example scenario, the second user may talk to the avatar. The system would detect and capture the voice of the second user. In some implementations, the system may cause the avatar to talk back to the second user, as if in a conversation. The system may use deep neural network and artificial intelligence technology to cause the avatar to interact with the second user. For example, the second user may ask the avatar a question. In response, the avatar may answer the question in the voice of the first user.

FIG. 4 is an example flow diagram for communicating with a user using an alternative digital voice, according to some implementations. Referring to both FIGS. 1 and 4, a method is initiated at block 402, where a system such as system 106 obtains an alternative set or second set of characteristics for the voice of the first user. This voice may be referred to as an alternative voice or second voice of the first user. The second voice may be, for example, a recorded voice of the same first user but at a younger age. In various implementations, there may be multiple recorded voices of the first user corresponding to different ages. As such, there may be multiple sets of characteristics for the voice of the first user for those respective ages.

In some implementations, the system may obtain the second set of characteristics for the first user's voice from any suitable local and/or remote storage location. In various implementations, the second set characteristics may be stored and transferred to the system in a file. In some implementations, the system may determine the second set of characteristics of the first user's voice based on a recorded voice. In this example implementation, the system may determine the characteristics of the second recorded voice in a similar manner to determining the characteristics of the first recorded voice, as described above in connection with FIG. 2.

At block 404, the system generates a second digital voice based on the second set of characteristics. The system generates the second digital voice in a similar manner to generating the digital voice, as described above in connection with block 204 of FIG. 2.

At block 408, the system enables a second user to select the second digital voice. For example, the system may present multiple voices to the second user (e.g., voices at different ages), and the second user may then select one (e.g., the second digital voice).

At block 410, the system communicates with the second user using the second digital voice. In other words, the system causes the avatar to communicate with the second user using the digital voice. The second digital voice may be appropriate if, for example, the system changes the avatar to visually represent the first user 20 years younger. As such, the system may enable the second user to select a digital voice corresponding to the first user, 20 years younger, for example.

While some implementations are described herein in the context of a memorial for a person who has passed away (e.g., preserving and playing the person's voice for others), the implementations and others may be applied to media associated with a person who is still alive. For example, the system may read printed material and output the content in the voice of the person who wrote the material.

Implementations enable a system to speak on behalf of a person who is not present (e.g., remote). Implementations enable a system to speak on behalf of a person who cannot speak. For example, the system may speak on behalf of a person who is losing their voice due to conditions such as amyotrophic lateral sclerosis (ALS) or other conditions such as aphasia, dysarthria, apraxia, etc.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations preserve a person's voice. Implementations provide longer lasting memories of people. Implementations described herein also enable users to hear alternative voices of a particular person (e.g., at different ages, etc.).

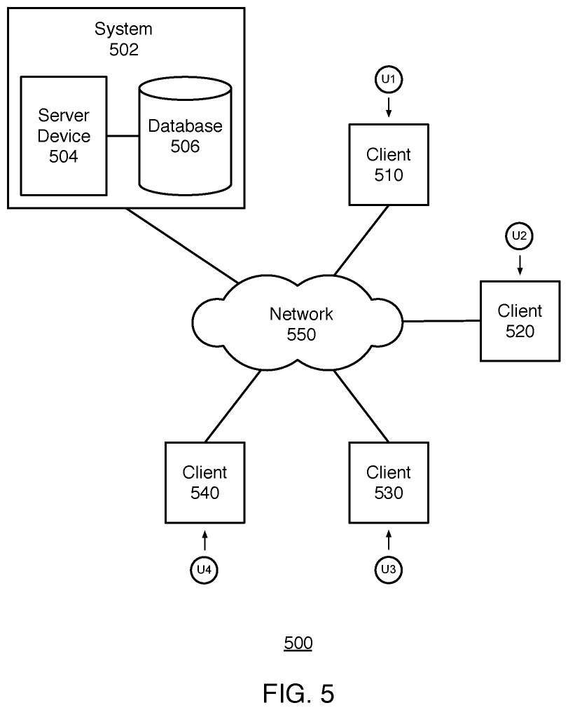

FIG. 5 is a block diagram of an example network environment, which may be used for implementations described herein. In some implementations, network environment 500 includes a system 502, which includes a server device 504 and a database 506. Network environment 500 also includes client devices 510, 520, 530, and 540, which may communicate with system 502 and/or may communicate with each other directly or via system 502. Network environment 500 also includes a network 550 through which system 502 and client devices 510, 520, 530, and 540 communicate. Network 550 may be any suitable communication network such as a Wi-Fi network, Bluetooth network, the Internet, etc.

In various implementations, system 502 may be used to implement system 106 of FIG. 1. Also, any of client devices 510, 520, 530, and 540 may be used to implement memorial 102 of FIG. 1.

For ease of illustration, FIG. 5 shows one block for each of system 502, server device 504, and network database 506, and shows four blocks for client devices 510, 520, 530, and 540. Blocks 502, 504, and 506 may represent multiple systems, server devices, and databases. Also, there may be any number of client devices. In other implementations, network environment 500 may not have all of the components shown and/or may have other elements including other types of elements instead of, or in addition to, those shown herein.

While server 504 of system 502 performs embodiments described herein, in other embodiments, any suitable component or combination of components associated with server 502 or any suitable processor or processors associated with server 502 may facilitate performing the embodiments described herein.

Implementations may apply to any network system and/or may apply locally for an individual user. For example, implementations described herein may be implemented by system 502 and/or any client device 510, 520, 530, and 540. System 502 may perform the implementations described herein on a stand-alone computer, tablet computer, smartphone, etc. System 502 and/or any of client devices 510, 520, 530, and 540 may perform implementations described herein individually or in combination with other devices.

In the various implementations described herein, a processor of system 502 and/or a processor of any client device 510, 520, 530, and 540 causes the elements described herein (e.g., avatar, etc.) to be displayed in a user interface on one or more display screens.

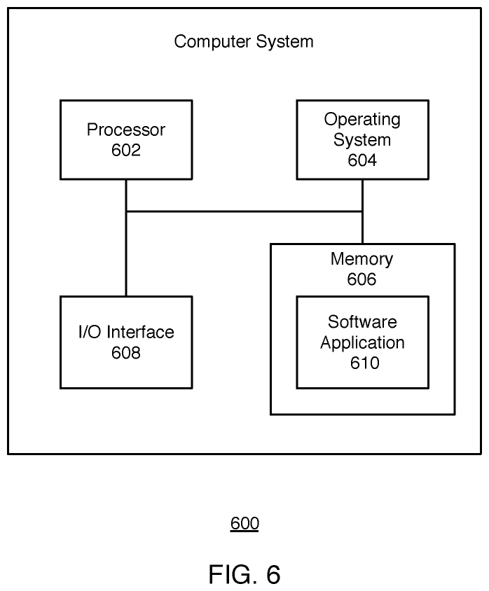

FIG. 6 is a block diagram of an example computer system 600, which may be used for some implementations described herein. For example, computer system 600 may be used to implement system 106 of FIG. 1, as well as to perform implementations described herein. In some implementations, computer system 600 may include a processor 602, an operating system 604, a memory 606, and an input/output (I/O) interface 608. In various implementations, processor 602 may be used to implement various functions and features described herein, as well as to perform the method implementations described herein. While processor 602 is described as performing implementations described herein, any suitable component or combination of components of computer system 600 or any suitable processor or processors associated with computer system 600 or any suitable system may perform the steps described. Implementations described herein may be carried out on a user device, on a server, or a combination of both.

Computer system 600 also includes a software application 610, which may be stored on memory 606 or on any other suitable storage location or computer-readable medium. Software application 610 provides instructions that enable processor 602 to perform the implementations described herein and other functions. Software application may also include an engine such as a network engine for performing various functions associated with one or more networks and network communications. The components of computer system 600 may be implemented by one or more processors or any combination of hardware devices, as well as any combination of hardware, software, firmware, etc.

For ease of illustration, FIG. 6 shows one block for each of processor 602, operating system 604, memory 606, I/O interface 608, and software application 610. These blocks 602, 604, 606, 608, and 610 may represent multiple processors, operating systems, memories, I/O interfaces, and software applications. In various implementations, computer system 600 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
obtaining a plurality of characteristics for a voice of a first user;
generating a digital voice based on the plurality of characteristics;
receiving input from a second user; and
communicating with the second user using the digital voice.

2. The system of claim 1, wherein the logic when executed is further operable to cause the one or more processors to perform operations comprising associating the digital voice with an avatar, and wherein the avatar communicates with the second user using the digital voice.

3. The system of claim 1, wherein the communicating is performed in a predetermined natural language.

4. The system of claim 1, wherein the input is text.

5. The system of claim 1, wherein the logic when executed is further operable to cause the one or more processors to perform operations comprising:
receiving text, wherein the input is the text;
converting the text to audio; and
outputting the audio in the digital voice.

6. The system of claim 1, wherein the input is audio.

7. The system of claim 1, wherein the logic when executed is further operable to cause the one or more processors to perform operations comprising:
obtaining a second plurality of characteristics for a second voice of the first user;
generating a second digital voice based on the second plurality of characteristics;
enabling the second user to select the second digital voice; and
communicating with the second user using the second digital voice.

8. A non-transitory computer-readable storage medium with program instructions stored thereon, the program instructions when executed by one or more processors are operable to cause the one or more processors to perform operations comprising:
obtaining a plurality of characteristics for a voice of a first user;
generating a digital voice based on the plurality of characteristics;
receiving input from a second user; and
communicating with the second user using the digital voice.

9. The computer-readable storage medium of claim 8, wherein the instructions when executed are further operable to cause the one or more processors to perform operations comprising associating the digital voice with an avatar, and wherein the avatar communicates with the second user using the digital voice.

10. The computer-readable storage medium of claim 8, wherein the communicating is performed in a predetermined natural language.

11. The computer-readable storage medium of claim 8, wherein the input is text.

12. The computer-readable storage medium of claim 8, wherein the instructions when executed are further operable to cause the one or more processors to perform operations comprising:
receiving text, wherein the input is the text;
converting the text to audio; and
outputting the audio in the digital voice.

13. The computer-readable storage medium of claim 8, wherein the input is audio.

14. The computer-readable storage medium of claim 8, wherein the instructions when executed are further operable to cause the one or more processors to perform operations comprising:
obtaining a second plurality of characteristics for a second voice of the first user;
generating a second digital voice based on the second plurality of characteristics;
enabling the second user to select the second digital voice; and
communicating with the second user using the second digital voice.

15. A computer-implemented method comprising:
obtaining a plurality of characteristics for a voice of a first user;
generating a digital voice based on the plurality of characteristics;
receiving input from a second user; and
communicating with the second user using the digital voice.

16. The method of claim 15, further comprising associating the digital voice with an avatar, and wherein the avatar communicates with the second user using the digital voice.

17. The method of claim 15, wherein the communicating is performed in a predetermined natural language.

18. The method of claim 15, further comprising wherein the input is text.

19. The method of claim 15, further comprising:
receiving text, wherein the input is the text;
converting the text to audio; and
outputting the audio in the digital voice.

20. The method of claim 15, wherein the input is audio.
